(19) United States
(12) Patent Application Publication
(10) Pub. No.: US 2005/0021602 A1
(43) Pub. Date: Jan. 27, 2005

(54) Local network for data exchange between portable micro-computers of aircraft passengers

(76) Inventors: Pierre Noel, Colomieres (FR); Jean-Yves Castros, Toulouse (FR); Alain Coupier, Toulouse (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/487,991

(22) PCT Filed: Jan. 31, 2003
(86) PCT No.: PCT/FR03/00303

(30) Foreign Application Priority Data
Feb. 5, 2002 (FR) 0201343

(51) Int. Cl. G06F 15/16

(52) U.S. Cl. 709/203

(57) ABSTRACT

The invention relates to the making available of “Internet” services, at the level of the seats (4) of a passenger cabin of an aircraft, in the case of aircraft that were not designed at the outset for such services but that have a passenger cabin provided with an electrical power distribution network serving groups (1, 2, 3) of passenger seats (4) by way of distribution boxes (9). It consists in mounting in the passenger cabin, a data exchange local area network with “Internet” access, dedicated to the portable microcomputers of the passengers, which uses network connection taps accessible from the passenger seats (4) complying with a regular standard for portable microcomputers and wireless links for joining these network connection taps to its server, interface cards ensuring the changes of standard at the level of the network connection taps and rendering the wireless links transparent to the user passengers.

The present invention relates to the cabling of the passenger cabin seats of an aircraft with the aim of providing the passengers with access to an information server for portable microcomputers.

More and more devices are being installed in passenger cabins to increase the sense of comfort at the level of the seats, in particular in long haul flights during which the passengers are destined to remain seated for quite a considerable time.

Thus the passenger cabin of long haul aircraft has very quickly been equipped with cinema projectors, then with collective video and finally with individual video with screens dispersed at the level of the seats, as well as with other devices placed at the level of the seats, such as telephone handsets, remote controls, audiophonic headphones, etc.

The equipping of certain passenger seats with individual telephone handsets, which is no longer appropriate, was done by means of a PABX onboard telephone exchange (the acronym standing for: Private Automatic Branch Exchange) placed in an equipment cabinet of the aircraft termed the avionics hold or “galley cabine”, connected to the various telephone handsets of the seats by cabled links disposed under the floor of the passenger cabin and put in touch with the terrestrial telephone network by way of onboard transmission equipment and of an air/ground communication system specialized for telephone traffic such as the “North American Telephone System” (NATS) or the “Terrestrial Flight Telecommunication System” (TFTS). However, the lack of success of the in-situ telephone service due to its high cost has meant that it is currently being replaced by a few telephone boxes dispersed within the passenger cabin, the cabling for wiring the cabled link between the PABX onboard telephone exchange and the passenger seats being dispensed with in order to reduce the total weight of the aircraft.

The art improving, one is now seeking to personalize the “audio/video” entertainment services offered to the passengers of long haul flights. Thus, the following are more and more frequently being found in the passenger cabin of the new long haul aircraft:
an onboard centralized distributor of audio and video programs
passenger seats individually equipped with a display screen SVD (the acronym standing for “Seat Video Display”) mounted, either on the back of the seat of the previous row, or on a support fixed to an armrest, with headsets H/S and with a remote control PCU (the acronym standing for “Passenger Control Unit”) making it possible to converse with the centralized distributor of “audio/video” programs so as to choose a program and adjust the listening and viewing comfort conditions,
an “audio/video” hookup cabling network placed under the floor of the passenger cabin, which links the centralized “audio/video” program distributor to the passenger seats equipped with display screens SVD, with headsets H/S or with remote control PCU, and which is accessible, at the level of a row of seats or of a group of seats, through distribution boxes termed ADBs: (the acronym standing for: “Area Distribution Box”), or FDB (the acronym standing for; “Floor Disconnect Box”), then with electronics terminals SEBs (the acronym standing for: “Seat Electronics Box”).

Additionally, it is envisaged to equip the passenger cabin of an aircraft with a data exchange local area network termed the cabin local area network or CWL (the acronym standing for: “Cabin Wireless LAN”). This cabin local area network CWL is composed of the following elements:
a computer server termed the NSU (the acronym standing for: Network Server Unit) linked by wire link to one or more wireless transceiver modules dubbed CWLU (the acronym standing for: “Cabin Wireless Lan Unit”) generally fixed to the ceiling of the cabin,
mobile radio transceivers equipping portable terminals assigned to the cabin staff, these portable terminals possibly being portable microcomputers equipped with specific network cards complying with the IEEE 802.11 standards.

The communications between this passenger cabin local area network and the exterior of this local area network are made by way of the NSU server. The latter can in particular be connected to another local area network individual to the airline or to the airport when the airplane is on the ground via a wireless transceiver device termed a “gate link”, the part of the kit situated on the aircraft being dubbed the TWLU (the acronym standing for: “Terminal Wireless Lan Unit”). It may also be connected to devices for transmitting data usable in flight such as VHF, HF radio or satellite transceivers. These devices generally being used also for transmissions that may be critical, this connection is not direct, but is made via the appropriate devices (firewalls) making it possible to guarantee the security and safety of the critical system.

With passengers more and more often bringing portable microcomputers (laptops) with them for work and pleasure, it is now frequently the case that their use is permitted during certain phases of flight (outside of the critical phases, while cruising mainly).

It is even envisaged that the use of a portable microcomputer at the level of a passenger seat be facilitated by making microcomputer power supply taps available to the passengers, at the level of their seats. This poses no particular problem insofar as the FDB/SEB distribution boxes already comprise an accessway to an electrical power network intended for supplying power to the individual display screens SVD, to the remote controls PCU and often to position adjustment motors with which the seats are equipped.

However, the passengers can only use their portable microcomputers in an isolated station with no access to the Internet information exchange network. Now, access to the Internet network by portable microcomputers is being demanded more and more since it allows information to be exchanged, while working, both between an individual who is traveling and his office or with business contacts, and also during leisure activities between networked players scattered around the planet.

To meet this requirement, it is currently envisaged that the passengers of long haul flights be enabled to use their portable microcomputers not only in an isolated station but also within a network with onboard aircraft Intranet access, then, in the near future, Internet access, thus offering them the possibility of exchanging e-mails and of consulting sites.

However, the networking of passenger portable microcomputers with possibility of Internet access involves the presence of taps for connection to a passenger local area network, that are accessible from the passenger seats, the presence of a passenger local area network server placed in an equipment cabinet of the aircraft and having Internet access by virtue of onboard transmission equipment using a digital air/ground communication system (VDL (the acronym standing for “VHF Digital Link”), Satcom, TWLU, etc.), and the presence of data transmission links connecting the server of the passenger local area network to the various network connection taps with which the passenger seats are equipped.

For the new aircraft, there is provision for the data transmission links connecting the server of the passenger local area network to the network connection taps with which the passenger seats are equipped to be produced by specific cabling.

For aircraft not designed at the outset with a view to use by passengers of networked portable microcomputers, the upgrading of the cabin cabling network is an unwieldy operation that is expensive in terms of the time for which the aircraft is grounded, and which can be contemplated only during a “D” maintenance check of the aircraft and which consequently cannot be envisaged quickly for most of the commercial aircraft currently in operation.

To alleviate this absence of cabling, the direct use by the passenger of the wireless transmissions of the CWLU local area network with which the passenger cabin may possibly be equipped for the benefit of the cabin staff cannot be envisaged since these wireless transmissions would require all the portable microcomputers of the passengers to be equipped with a network interface card complying with the IEE 802.11 standard, this being a highly improbable situation, all the more so since experience has shown that the cards governed by this standard are not all necessarily compatible with one another if they emanate from different manufacturers.

The problem of the upgrading, in a minimum time for which the aircraft is grounded, of the comfort equipment of the passenger cabin of existing aircraft remains unanswered to this day. The aim of the present invention is to solve it.

It's subject is a data exchange local area network for the portable microcomputers of the passengers of an aircraft, with a passenger cabin provided with passenger seats and with an electrical cabling network for the passenger seats ensuring at least a distribution of electrical power by way of distribution boxes serving groups of passenger seats. This data exchange local area network for the portable microcomputers of passengers comprises at least one network server placed in an equipment cabinet of the aircraft (avionics hold or “galley cabine” as the case may be), network connection taps accessible from the passenger seats and data exchange links between the network server and the network taps accessible from the passenger seats. It is characterized in that the data exchange links are wireless links effected by means of two groups of wireless transmission transceivers conversing with one another, a first group of transceivers dispersed over the inside wall of the passenger cabin and hooked up to the network server by a cabled link and a second group of transceivers dispersed within the passenger cabin at the level of the distribution boxes serving groups of passenger seats, supplied with electrical power by the distribution boxes and hooked up to the network connection taps accessible from the passenger seats, by way of wireless network/wire network interface cards.

Advantageously, the wireless network/wire network interface cards are provided with concentrators making it possible to share the accessways to the wireless transceivers equipped therewith between several network connection taps accessible from the passenger seats.

Advantageously, the wireless links are optical links.

Advantageously, the wireless links are infrared links.

Advantageously, the wireless links are radio links.

Advantageously, the wireless links are spreadband radio links.

Advantageously, the wireless links are spreadband radio links obtained through frequency hops.

Advantageously, the wireless links are spreadband radio links obtained by modulation with the aid of pseudo-random binary sequences.

Advantageously, the transceivers of the second group as well as the interface cards are placed in the distribution boxes.

Advantageously, the interface cards comply, wire network side, with a serial transmission norm of the Universal Serial Bus type to which the network connection taps accessible from the passenger seats also conform.

Advantageously, the interface cards comply, wire network side, with a serial transmission norm of the Ethernet type to which the network connection taps accessible from the passenger seats also conform.

Advantageously, the interface cards comply, wire network side, with a serial transmission norm which conforms to the V90 recommendation of the International Telecommunications Union, the network connection taps accessible from the passenger seats being telephone taps.

Advantageously, the interface cards comply, wire network side, with a serial transmission norm which conforms to the V92 recommendation of the International Telecommunications Union, the network connection taps accessible from the passenger seats being telephone taps.

Other characteristics and advantages of the invention will emerge from the description below of an exemplary embodiment. This description will be given in conjunction with the drawing in which:

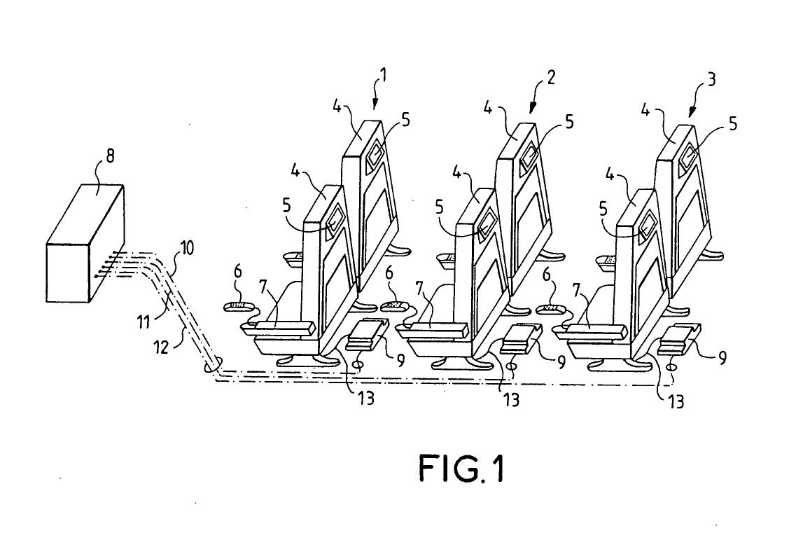

a FIG. 1 is a perspective view showing the customary cabling plan of a passenger cabin equipped with seats with individualized audio/video service, and

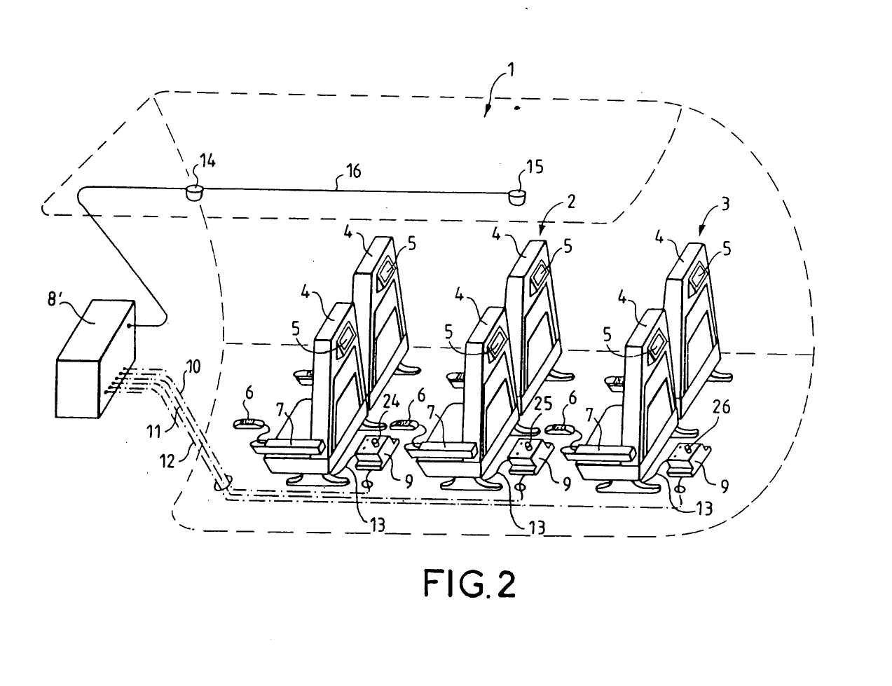

a FIG. 2 illustrates the use of the distribution boxes of the existing cabling in a passenger cabin equipped with seats with individualized audio/visual service, for deploying a data exchange local area network dedicated to the portable microcomputers of the passengers.

FIG. 1 shows three rows 1, 2, 3 each of two passenger seats 4 and arranged on the same side of an aisle in a passenger cabin of a commercial aircraft. Each passenger seat 4 is equipped for an à la carte audio/video service, with a flat display screen 5 fixed on the rear of its back for the benefit of the passenger seated in the seat of the next row, with a remote control 6 accessible from one 7 of its armrests as well as with a tap (not visible in the figure) for headsets that is also accessible from one of the armrests. These various audio/video accessories 5, 6 with which each passenger seat 4 is individually equipped are hooked up by multiconductor cabled links to a central distributor 8 of à la carte audio/video programs that is placed in an equipment cabinet of the aircraft.

With the aim of simplifying and streamlining the cabling traversing the passenger cabin, the multiconductor cabled links connecting the central distributor 8 of audio/video programs to the individual audio/video equipment 5, 6 of the passenger seats 4 pass through distribution boxes 9 that are dispersed inside the passenger cabin and serve groups of passenger seats 4. Between the central distributor of audio/video programs 8 and the distribution boxes 9, the cable bundles follow cableways 10, 11, 12 disposed under the floor of the passenger cabin and hence inaccessible from inside the latter. The cable bundles originating from the central distributor 8 of audio/video programs leave the floor of the passenger cabin in the immediate vicinity of the distribution boxes 9. They terminate in the latter at relay connectors which enable them to be hooked up, in a detachable manner, to cabling 13 placed in the structure of the passenger seats 4 and terminating at their individual audio/video equipment 5, 6.

The distribution boxes 9 each serve a group of two, three or four passenger seats 4, in fact the passenger seats 4 of one and the same row, which are arranged side by side, either between two aisles, or between an aisle and the wall of the passenger cabin. They are fixed under the passenger seats at accessible locations that are, however, may inconvenient in respect of the comfort of the passenger and in respect of traffic in the aisles. They comprise an accessway to an onboard power supply network allowing the provision of electrical power to the electrical equipment of the passenger seats 4, in particular their flat display screen 5, their remote control 6 and often position adjusting motors. It is therefore easy to equip them with mounts for electrical taps with a view to providing a power supply to the portable microcomputers of the passengers whose endurance when running on accumulators is often limited.

FIG. 2 shows the modifications made to the equipment and the cabling of the passenger cabin illustrated in the previous figure, for the cheaper installation of a data exchange local area network dedicated to the portable microcomputers of the passengers.

The distributor of à la carte audio/video programs 8 is supplemented with a data exchange local area network server, with Internet access, dedicated to the portable microcomputers of the passengers, the whole being disposed in an equipment cabinet of the aircraft and represented by a trunk 8′ in FIG. 2.

This local area network server communicates both with the Internet network, outside the aircraft, by means of onboard transmission equipment to which it is hooked up by wire links and of air/ground communication systems specialized for aeronautical and/or telephonic communications as the case may be (for the existing, retrofit market, there is a great variety of airplane equipment and great variety of airplanes, etc.) and, with the microcomputers of the passengers inside the passenger cabin, by means of wireless links using two groups of wireless transceivers communicating between one another:
a first group of wireless transceivers 14, 15 that are hooked up by an additional cabled link 16 and that are dispersed over the inside walls of the passenger cabin, so as to cover the cabin volume planned for the development of the data exchange local area network dedicated to the portable microcomputers of the passengers,
a second group of wireless transceivers 24, 25, 26 that are compatible with those 14, 15 of the first group, that are placed on, in or in proximity to the distribution boxes 9 from which they derive their electrical power supplies, and that are hooked up, by way of interface cards providing for the wireless network/wire network transition, to network connection taps made available to the passengers.

The first group of wireless transceivers can be installed for example underneath the cabin luggage bins, level with the buttons made available to the passengers for adjusting their individual lighting and their individual ventilation or else plumb with the aisles of the cabin.

The wireless transceivers 24, 25, 26 of the second group, the interface cards providing for the wireless network/wire network transition and the accessible network connection taps of the passengers may be mounted in or on the distribution boxes or else in the structures of the groups of passenger seats served.

The two groups of transceivers placed at the ends of the wireless links between the server and the local area network and the portable microcomputers of the passengers may be of optical or radio transmission types.

When they are of optical transmission type, they advantageously use the infrared band.

When they are of radio transmission type, they advantageously use the spreadband technique to reduce the risks of interference with the onboard radio equipment by diluting the power of the radio signals transmitted inside the cabin within a wide frequency span. The band spreading may be obtained by frequency hops or by modulation with the aid of pseudo-random binary sequences.

More generally, the radio transceivers used for the wireless transmissions within the local area network dedicated to the microcomputers of the passengers may have similar characteristics to those of the radio transceivers of the CWLU local area network dedicated to the cabin staff and comply with the ARINC 763 and IEEE 802.11 standards. They may also comply with other standards or serial transmission norms such as a Telecom standard or “Bluetooth” standard.

The interface cards providing for the wireless network/wire network transition make it possible to go from the standard used within the local area network dedicated to the portable microcomputers of the passengers and which may be very specific as in the case of the CWLU network, to a widespread standard among mass-market portable microcomputers such as an Ethernet standard or a USB standard (the acronym standing for: “Universal Serial Bus”) or else a telephone standard for modem such as the V90, V92 standards of the International Telecommunications Union. They are advantageously equipped with concentrators making it possible to split the input/output port to the local area network provided by a wireless transceiver powered via a distribution box into as many input/output ports as are necessary for the number of passenger seats served by the distribution box.

The form of the network connection taps accessible from the passenger seats is indicative of the serial communication standard made available. Specifically, these network connection taps conform to the standard complied with, wire network side, by the interface cards. If this standard is an Ethernet standard, then they are Ethernet taps. If this standard is a USB standard, then they are USB taps. If this standard is a V90 or V92 telephone standard, then they are telephone taps.

The data exchange local area network dedicated to the portable microcomputers of the passengers that has just been proposed, has the advantage of being able to be produced from equipment already available off the shelf from manufacturers and complying with proven standards (CWLU, IEEE 802.11, ARINC 763, USB, “Bluetooth”, V90, V92), and of being easy to install since it involves only simple and inconsiderable additional cabling of the passenger cabin of an aircraft. It affords new passenger-valued communication services such as the consulting of Internet sites, the exchanging of messages and of e-mails with their contacts remaining on land or networked game playing. An airline getting new aircraft designed from the outset to give passengers Internet access is thus able to upgrade its other aircraft more cheaply.

1. A data exchange local area network for portable microcomputers of passengers of an aircraft, with a passenger cabin provided with passenger seats and with an electrical cabling network for the passenger seats ensuring a distribution of electrical power by way of distribution boxes serving groups of passenger seats, comprising:
a network server placed in an equipment cabinet of the aircraft, a plurality of network connection taps accessible from the passenger seats and data exchange links between the network server and the network taps accessible from the passenger seats,
wherein the data exchange links are wireless links effected by two groups of wireless transmission transceivers conversing with one another,
a first group of transceivers dispersed over an inside area of the passenger cabin and hooked up to the network server by a cabled link;
and a second group of transceivers dispersed within the passenger cabin at the level of the distribution boxes serving groups of passenger seats, supplied with electrical power by the distribution boxes and hooked up to the network connection taps accessible from the passenger seats, by a plurality of wireless network/wire network interface cards.

2. The local area network as claimed in claim 1, wherein the interface cards have with concentrators making it possible to share accessways to the wireless transceivers equipped therewith between several network connection taps accessible from the passenger seats.

3. The local area network as claimed in claim 1, wherein the wireless links are optical links.

4. The local area network as claimed in claim 3, wherein the wireless links are infrared links.

5. The local area network as claimed in claim 1, wherein the wireless links are radio links.

6. The local area network as claimed in claim 5, wherein the wireless links are spreadband radio links.

7. The local area network as claimed in claim 5, wherein the wireless links are spreadband radio links obtained through frequency hops.

8. The local area network as claimed in claim 5, wherein the wireless links are spreadband radio links obtained by modulation with the aid of pseudo-random binary sequences.

9. The local area network as claimed in claim 1, wherein the transceivers of the second group as well as the interface cards are disposed in the distribution boxes.

10. The local area network as claimed in claim 1, wherein the interface cards comply, wire network side, with a Universal Serial Bus standard to which the network connection taps accessible from the passenger seats also conform.

11. The local area network as claimed in claim 1, wherein the interface cards comply, wire network side, with an Ethernet standard to which the network connection taps accessible from the passenger seats also conform.

12. The local area network as claimed in claim 1, wherein the interface cards comply, wire network side, with the V90 recommendation of the International Telecommunications Union, the network connection taps accessible from the passenger seats being telephone taps.

13. The local area network as claimed in claim 1, wherein the interface cards comply, wire network side, with the V92 recommendation of the International Telecommunications Union, the network connection taps accessible from the passenger seats being telephone taps.
